(19) United States
(12) Patent Application Publication
(10) Pub. No.: US 2002/0026326 A1
(43) Pub. Date: Feb. 28, 2002

(54) Business method to manage the non-waste handling elements of solid waste management

(76) Inventor: James Nelson Stevens, Weaverville, CA (US)

Correspondence Address: JAMES NELSON STEVENS, P.O. Box 805, WEAVERVILLE, CA, 96093, US

(21) Appl. No.: 09/930,595

(22) Filed: Aug. 15, 2001

Related U.S. Application Data
(60) Provisional application No. 60/227,353, filed on Aug. 24, 2000.

(51) Int. Cl. G06F 17/60

(52) U.S. Cl. 705/1; 705/14

(57) ABSTRACT

An improved method of communication, control and command for patron functional services for solid waste management districts to minimize solid waste and solid waste management costs and maximize recycling and convenience. The publicly accessible solid waste disposal site is to be equipped with area lighting, video camera(s), a means for patrons to communicate identity and service data and a means to transmit and receive video and other data to and from remote data management facilities. The patron is required to identify his or her self each time he or she utilizes a public solid waste disposal facility. Commercial haulers are required to identify themselves and the source of the waste and provide a volume estimate. The camera(s) verify compliance. The remote data management facilities communicate with patrons, maintain records, calculate billings and monitor public solid waste deposit facility video camera(s) for security, maintenance needs and compliance verification. Two operational elements predominate: The patron is identified at the solid waste deposit facility and bill reductions are granted for demonstrated waste minimization, both of which may be accomplished in numerous ways. Identifying the patron demonstrates the patron's physical presence at the solid waste disposal facility. In that the patron is required to be present at the solid waste disposal facility periodically, and in that billing is not relative to discarded waste volume, there is no advantage to illegal roadside dumping. Waste minimization is measured by demonstrated proactive conservation efforts rather than by discarded waste volumes. This allows a totally automated solid waste disposal facility.

### CROSS-REFERENCE TO RELATED APPLICATIONS

This application is entitled to the benefit of Provisional Patent Application Ser. No. 60 227 353, filed Aug. 24, 2000.

### BACKGROUND-FIELD OF INVENTION

This invention relates to solid waste management, specifically to all those service matters not related to the actual handling of the waste itself, including, but not limited to, form, format, feeing, billing, compliance, security, communication, policing, monitoring, recycling and functional analysis.

### BACKGROUND-DISCUSSION OF PRIOR ART

What once was called trash, junk, garbage, refuse, etcetera, is now known technically as solid waste. District, city, town or county governments manage solid waste disposal locally. Payment for this service is collected through property taxes, annual assessments, periodic billings, gate fees, tipping fees or combinations of any number of these. Problems with these funding methods are:

a) property taxes and annual assessments work a hardship on the patron;

b) property taxes and annual assessments cause cash flow difficulties for the solid waste management district;

c) periodic billings on a small scale are prohibitively expensive;

d) gate fees and tipping fees promote illegal roadside dumping, which contaminates waterways and requires an increase in fees to cover lost gate and tipping fee revenue and remediation costs.

Where population densities are sufficient to provide economic incentive, private curbside pickup services are available that can, because each customer is individually serviced, bill the patron in proportion to the volume of waste removed. This service provides a platform for Sliding Scale Feeing. Higher density populations also enjoy the benefits of economy-of-scale.

Sliding Scale Feeing is the practice of billing on a curve instead of a straight line; i.e., one garbage can costs one dollar to dump, 2 garbage cans cost 4 dollars to dump, 3 garbage cans cost 9 dollars . . . Sliding Scale Feeing is a stratagem that significantly reduces waste generation. Where population densities are insufficient to provide economic incentive for private curbside pickup services, each individual must haul his or her own solid waste to a disposal site. A solid waste disposal site is a, or a combination of;

a) transfer site where solid waste is deposited for shipment to other facilities;

b) material recovery facility where solid waste is separated into various categories before final disposition, which may include burying, burning, composting, recycling;

c) landfill where solid waste is buried;

d) incinerator or co-generation facility where solid waste is burned.

An attendant must be available at each disposal site to assess volumes, if the patron is to be billed proportionately and if Sliding Scale Feeing is to be employed. The low economic base commonly prevalent in low population density areas, precludes the general use of attendants. The disadvantages associated with these conditions are:

a) individual cells within a landfill are filled more quickly, accelerating cell preparation and closure, which increases operating costs;

b) landfills are filled more quickly, exasperating landfill space location shortage and increasing landfill purchase, preparation, operating, closure and monitoring costs;

c) individual patron costs are disproportionately high, inequitable, unfair and unjust;

d) effective waste reduction efforts are incapacitated;

e) scattered refuse and vandalism is uncontrolled in unattended solid waste disposal sites;

f) attended solid waste disposal sites, because of work-hour limitations, have limited accessibility;

g) unattended solid waste disposal sites and equipment are unguarded against theft, fire, wildlife mischief, and vandalism;

h) economy-of-scale is unachievable;

i) immediate maintenance needs at unattended sites are unrecognized;

j) personnel must regularly travel long distances to unattended sites to assess maintenance needs.

Acts of Congress mandate that recycling is a function of solid waste management. Manufacturers and professional recyclers require recyclable materials be separated by type and certain types specifically prepared. Normal human error, inattention, carelessness, indifference and caprice require that all materials being submitted for recycling are inspected to assure they are properly prepared and separated. Some recyclable materials have intrinsic cash value, and in addition, some have specific legally mandated redemption cash value. A bonded agent is required to monitor, inspect, classify, weigh, record, and calculate and pay the cash value to the individuals bringing the recyclables to the recycle center.

Low population density areas, again because of limited tax base, are unable to provide full-service bonded attendants at all waste disposal sites. Full-service recycling at these waste disposal sites is not possible. The disadvantages associated with this are:

a) patrons have limited recycling options;

b) patrons cannot obtain recycling deposit refunds;

c) patrons cannot receive intrinsic cash value for recyclable materials;

d) a significant waste reduction methodology is disabled;

e) waste management districts are unable to meet legal recycling mandates economically;

f) costs of recycling are increased;

g) recycling is discouraged.

Low population density solid waste management districts historically had provided, or allowed to develop spontaneously, minimal open-burn dumps at variously convenient locations. These operations required minimal service at insignificant cost. Recent congressional mandate requires solid waste management to use scientific methodology. Solid waste management districts are undergoing enormous and expensive technological expansion. Each solid waste management district, while struggling to fund the resultant major cost increases, have necessarily given deficient attention to those solid waste services not associated with the direct handling of solid waste itself. This situation is especially acute in the low population density area, which is usually associated with a low economic base.

Scientific solid waste management is a new discipline and most solid waste managers have only on-the-job experience. Only most recently has the subject been offered by educational institutions in degreed programs. Those programs concentrate primarily on the scientific management of the waste itself. The inordinate complexity of the non-waste handling service requirements have baffled all those not dedicated to long-term, in-depth analysis of the subject. These matters traditionally are decided for each individual solid waste management district by local short-term elected officials uneducated in solid waste management. As a result, patron service is grossly inadequate, scaled collaboration is unknown, elements directly effecting recycling and waste reduction are inefficiently addressed, and the poorest possible economy exists.

### SUMMARY

My invention inverts the historical process of charging either a flat rate, or charging for the amount of solid waste thrown away, by charging everyone equally and then reducing charges for those demonstrating waste conservation and recouping the lost revenue by adding to the charges of those not so demonstrating. In that the patron is required to visit the solid waste disposal facility periodically and will be billed regardless of the number of visits, illegal roadside dumping is without advantage. My invention minimizes solid waste, illegal dumping and solid waste management costs. Furthermore, my invention maximizes recycling and utility for the patron.

### OBJECTS AND ADVANTAGES

Accordingly, several objects and advantages of my invention are:

a) to reduce solid waste generation;

b) to reduce solid waste landfill site proliferation

c) to increase solid waste landfill cell life;

d) to reduce solid waste management costs;

e) to eliminate inequitable solid waste feeing;

f) to control solid waste deposit site vandalism;

g) to reduce solid waste deposit site wildlife mischief;

h) to increase solid waste deposit site safety;

i) to monitor solid waste deposit site maintenance needs;

j) to assure solid waste deposit site and equipment security;

k) to provide solid waste Sliding Scale Feeing to promote waste conservation;

i) to open solid waste deposit sites around-the-clock for patron convenience;

m) to increase recycling;

n) to assure that intrinsic cash values are paid to patrons returning recyclable materials;

o) to assure that recycle refunds are paid to patrons returning recyclables;

p) to reduce the costs of recycling to solid waste management districts;

q) to assure that recycling mandates to solid waste management districts are met economically.

Further objects and advantages of my invention will become apparent from a consideration of the ensuing descriptions.

### DESCRIPTION OF INVENTION

Preferred Embodiment

The preferred embodiment is comprised of two elements; the solid waste disposal site and data management.

The solid waste disposal site, in addition to the requisite solid waste materials management equipment, shall also be equipped with:

1. a computer. The computer shall be interconnected with the Internet and other electronic and electrical devices within the solid waste disposal site as required;

2. an electronic camera(s);

3. a means to identify patrons. This means may be, but not necessarily must be, provided by electronic keypad, equivalent in purpose to, but not necessarily identical to, a standard alpha-numeric telephone keypad, or other device(s) capable of translating alpha-numeric information into electronic data, or license plate reading electronic system, or voice recognition electronic system, or by means not yet created;

4. an area lighting system;

5. a means suitable to deny entry to or to repel bears when and where required. This means may, but not necessarily must, include fencing, electric shock, noise makers or by means not yet created.

Data management is comprised of:

A. computer(s), connected to the Internet;

B. remote service representative(s). This function may be partially or wholly automated.

### OPERATION OF INVENTION

Equipment Function of the Solid Waste Disposal Site

1. The computer will store and transmit pictures and other data. The computer will control electronic and electrical systems associated with the solid waste disposal site. The computer will receive instruction and transmit data via the Internet.

2. The electronic camera(s) will be located as required to view the entire facility and record vehicle license plates. The electronic camera(s) will be controlled by motion and/or vehicle sensors and commands from the computer. The electronic camera(s) will transmit data and pictures to and receive instructions from the computer;

3. The means to identify patrons, as previously described, will be located conveniently accessible to drivers of vehicles entering the site. Drivers entering the solid waste disposal site will each enter an identification code into the system chosen. The system chosen will transmit inputted data to the computer;

4. The area lighting system will provide night vision for site visitors. The area lighting system may be controlled by light sensors to operate during periods of darkness and will operate on command for remote viewing. Motion or vehicle sensors may operate the lighting system when the premises are occupied.

System Function of the Solid Waste Disposal Site

Anyone may enter the solid waste disposal site at any time. The area lighting system (4) will operate automatically. The license plate of each vehicle will be recorded by the camera(s) (2) upon entry.

The enrolled patron will provide an individual personal identification number (PIN) through the electronic keypad or other device(s) of similar purpose (3) upon entering the solid waste disposal site. Prolonged absence of any particular PIN number activity will instigate an inquiry as to the legal alternative solid waste disposal method being used. As there are no gate or tipping fees, and as the patron must visit a solid waste disposal site on a recurring basis to keep a PIN number active to avoid inquiry, and as the patron will be billed on a regular basis irrespective of the number of visits, illegal roadside dumping provides no advantage.

Commercial solid waste service vehicle drivers will provide an assigned identification code and a volume estimate through the electronic keypad or other device(s) of similar purpose (3). The identification code will, via the computer (1), cause the electronic camera(s) (2) to record the tipping (discharge) of the waste. This recording allows visual confirmation of the volume estimate.

Commercial haulers other than solid waste service vehicles, e.g., construction contractors, gardeners, roofers, etcetera, shall provide a case specific identification code which identifies the property from which the waste came, and a volume estimate through the electronic keypad or other device(s) of similar purpose (3). The case specific identification code may be obtained from a service representative anytime prior to tipping The identification code will, via the computer (1), cause the electronic camera(s) (2) to record the tipping for visual confirmation of volume estimate.

Un-enrolled visitors may utilize a described solid waste disposal site without a PIN number. The vehicle license will be recorded by the electronic camera(s) (2). The license number will be entered into a data base and compared to other similar entries to identify habitual un-enrolled visitors.

Equipment Function of Data Management

The computer(s) (A) will be used to:

1. view any solid waste disposal site at any time via Internet for security, maintenance inspection, tipping verification, etcetera;

2. send and receive data to and from each solid waste disposal site;

3. calculate billings. This may be based in part or entirely on solid waste character and volume data, waste reduction compliance and patron, demographic and census data;

4. conduct any other common business office computer chores.

Remote service representative(s) (B) will:

1. service patrons . This may utilize any or all common communication systems, e.g., mail, telephone, computer, Internet, fax, and method not yet created, etcetera, and may include receiving patron data and making record changes and corrections;

2. view solid waste disposal sites to verify tipping. Maintenance, fire, safety and security needs may be identified;

3. Communicate maintenance, fire, safety and security needs to relative service provider(s);

4. enter data and instructions into the computer(s) (A);

5. perform any other common business office chores.

System Function of Data Management

Information derived from a variety of sources, which may include demographic, legal, tax rolls, census abstracts, motor vehicle records, PIN, school attendance records, solid waste volume and character analysis, vacancies, patron grant requests, solid waste management district operating costs, compliance ratio, remediation budget, and overhead, will be used to calculate individual billings. The billings will be sent to all residence, institution, government and business places.

The commercial bill, e.g., institution, government, business, will show the actual volumes of solid waste generated and the cost for that billing period calculated from tipping volume estimates, verified by camera. Commercials will be billed on a sliding scale based on volume and content. Recyclable, reusable and replaceable high-waste elements of commercial solid waste will be billed at a higher rate than non-reducible waste.

The resident bill will show the estimated volumes of solid waste generated by, and it's costs to, each individual member of that household for that billing period. Residents will be billed at the maximum rate for a maximum sized family and then may reduce their costs through grants given for demonstrating any means that reduces solid waste, e.g., home grown foods, recycling receipts, restaurant receipts showing higher than normal use, children (generate less waste than adults), composting, worms and other waste consuming animals and systems, selective purchasing, smaller household composition, waste compactor, etcetera.

### CONCLUSION, RAMIFICATIONS AND SCOPE OF INVENTION

By requiring the patron to periodically visit the solid waste disposal facility and billing regardless of the number of visits or quantity of waste deposited, there is no advantage to illegal roadside dumping. By directly rewarding the patron for waste minimization efforts and passing that cost on to those not doing so, an effective sliding-scale feeing schedule is created which has been shown to effectively minimize solid waste profligacy. Thus the reader can see that my invention creates a new paradigm in solid waste management that proactively addresses heretofore neglected elements that have prevented full implementation of waste minimization efforts.

While my above description contains many specificities, these should not be construed as limitations on the scope of my invention, but rather as exemplification of one preferred embodiment thereof. Other variations may be possible.

Accordingly, the scope of my invention should be determined not by the embodiment given, but by the appended claims and their legal equivalents.

I claim:

1. A service bureau to manage the patron (customer) interface with solid waste management systems which, in conjunction with other common existing components, is comprised of two elements;
1. identification of patrons entering solid waste deposit facilities,
2. a system of reward for patrons demonstrating waste conservation.
